(19) United States
(12) Patent Application Publication
(10) Pub. No.: US 2001/0049867 A1
(43) Pub. Date: Dec. 13, 2001

(54) Vacuum cinerary jar

(76) Inventor: Shou-Tang Tseng, Taichung (TW)

Correspondence Address: BACON & THOMAS, PLLC, 625 SLATERS LANE, FOURTH FLOOR, ALEXANDRIA, VA, 22314

(21) Appl. No.: 09/863,337

(22) Filed: May 24, 2001

(30) Foreign Application Priority Data
Jun. 2, 2000 (TW) 089209573

(51) Int. Cl. A61G 17/00

(52) U.S. Cl. 27/1; 220/212; 40/455

(57) ABSTRACT

A vacuum cinerary jar contains the remains or cremains of human beings or pets, a cover as a C-ring link component to compact the only top open of the foresaid main body in pressurization. A vacuum pump set on the cover, in which there is a stationary base and a piston respectively that set the first non-return valve and the second non-return valve. Utilizing the reciprocating motion of foresaid piston of a manual or electric operating shaft in pump to make the foresaid first and second non-return valve open on different time via resist-compressed action so as to cause the air in the jar extracted unidirectionally. Keeping the reciprocating motion of the foresaid operating shaft goes down to the setting of vacuum degree in the airtight jar.

### BACKGROUND OF THE INVENTION

1. Filed of the Invention

The present invention relates to a storage container of cremains for the remains of human beings or pets, and in particular to a vacuum cinerary jar that preserves bones or cremains in vacuum state via manual or electric operating pump.

2. Description of the Prior Art

Due to the inadequate land resources and environmental consciousness now, people replace interment with cremation. Even the cremains by cremation or the collection of remains buried for years, they are settled in a china-made cinerary jar.

Some hygroscopic materials such as charcoal generally used to put in the jars to prevent the remains from damp to cause spoiled. However, no matter what kind of hygroscopic material they put inside, it will come to saturation and lose its moisture-absorbing to result in the remains being spoiled.

Accordingly, since the used cinerary jar cannot completely separate the remains and cremains inside jar from the outside air, the remains and cremains would be spoiled by the chemical change of the contact of various bacteria and germs in the air. Therefore, on the basis of the defects of cinerary jar mentioned above, the inventor innovates this vacuum cinerary jar.

### SUMMARY OF THE INVENTION

The present invention generally relates to extract the air from a vacuum cinerary jar via manual or electric operating pump to completely isolate the remains and cremains inside jar from the outside air so that the remains and cremains would not be spoiled and be preserved for tong range.

Another purpose of the present invention is to provide a foresaid vacuum cinerary jar with simple operation and operate repeatedly to keep the cinerary jar vacuum.

Meanwhile, the present invention is to provide a foresaid vacuum cinerary jar to prevent the outside heat source from conducting in order to avoid the remains inside the jar spoiling.

Another feature of the present invention is related to a beeper set on the foresaid vacuum cinerary jar to selectively broadcast the sound as chant or music.

Consequently, to attain the foresaid purposes relates to a main body that contains the remains or cremains of human beings or pets, a cover as a C-ring link component to compact the only end of open of the foresaid main body in pressurization. A vacuum pump set on the cover, in which there is a stationary base and a piston respectively that set the first non-return valve and the second non-return valve. Utilizing the reciprocating motion of foresaid piston of a manual or electric operating shaft in pump to make the foresaid first and second non-return valve open on different time via resist-compressed action so as to cause the air in the jar extracted unidirectionally. Keeping the reciprocating motion of the foresaid operating shaft goes down to the setting of vacuum degree in the airtight jar.

The foresaid vacuum cinerary jar comprises a beeper, in which utilizing a power V provided by a battery and the power terminal connect with a switch S1. When turning on the switch, an electric current transmits to pass an electric resistance R1 then to pass LED to light up so as to show the status of conduction. Furthermore, the electric current transmits a voice integrated circuit IC that is completed by burnt. The two electric terminals of the foresaid voice integrated circuit IC connect with R2 as musical scale adjuster and collocate an amplifier that consists of Rx, Cx and a transistor Q1. After amplifying the burnt circuit such as the voice integrated circuit IC of chant or music transmit the musical scale adjuster and voice amplifier, the sound such as chant or music can be amplify via the amplifier.

### BRIEF DESCRIPTION OF THE DRAWINGS

The drawings disclose an illustrative embodiment of the present invention which serves to exemplify the various advantages and objects hereof, and are as follows:

FIG. 1 is a top stereoscopic view in the present invention as a vacuum cinerary jar.

FIG. 2 is a vertical exploded view in the present invention.

FIG. 3 is a partial amplified exploded view of FIG. 2 in the present invention.

FIG. 4 is similar to FIG. 3, but the piston of FIG. 4 is put downward to tower place.

FIG. 5 is a circuit diagram of beeper in the present invention.

### DETAILED DESCRIPTION OF THE PREFERRED EMBODIMENT

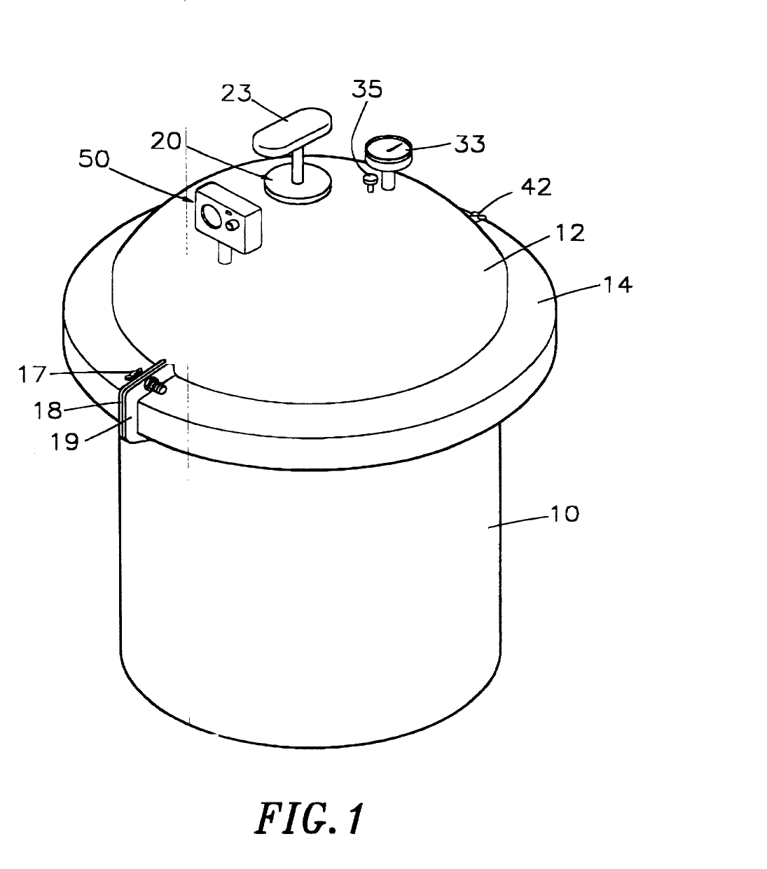

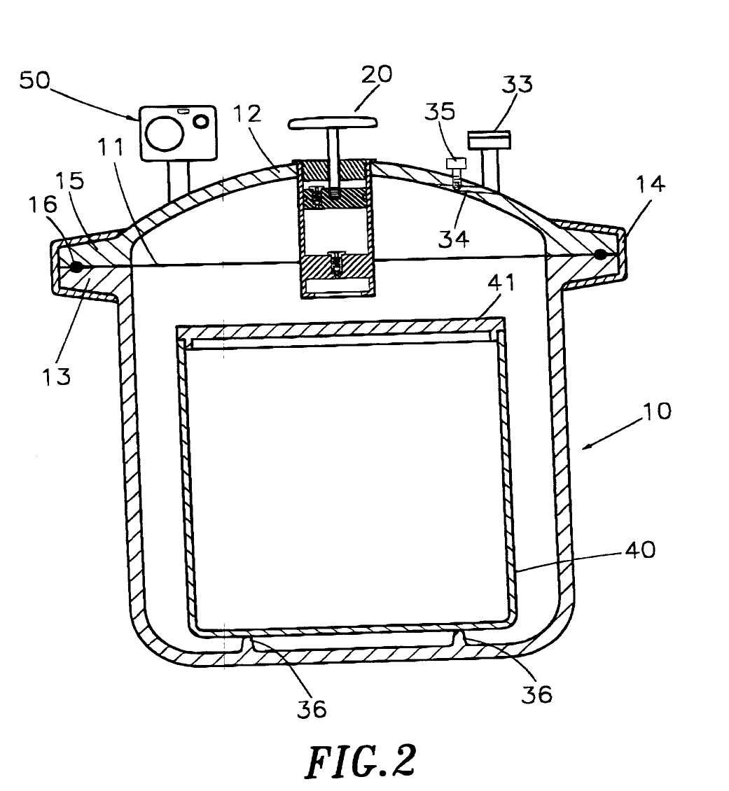

First of all, referring to FIGS. 1 and 2 simultaneously, the vacuum cinerary jar of the invention comprises a main body 10 made by metal or other proper material, in which the inner part is cannular but with the only top open 11 to contain the remains or cremains of human beings or pets. The edge of top open 11 of main body 10 has a protruding ring rim 13 to be topped with an upper protruding ring 15 in which set a O ring protection element 16 and its cover 12 compresses the main body 10 with a C-ring link component 14 completely or partially encompassing to keep pressurization with a screw bolt 17 to tighten two edges of protruding pieces 18, 19. In order to open C-ring link component 14 readily, a pivot component as a chain 42 on the opposite site of the two edges of protruding pieces 18, 19 is used to unfold the C-ring link component 14 to an unlocked angle. Extracting the air from vacuum pump 20 via manual or electric operating pump to completely isolate the remains and cremains inside jar from the outside air so that the remains and cremains would not be spoiled and be preserved for long range.

The foresaid component 14 can be tightened by a bolt, thread rotate or other lock conformation besides C-ring link to keep pressurization.

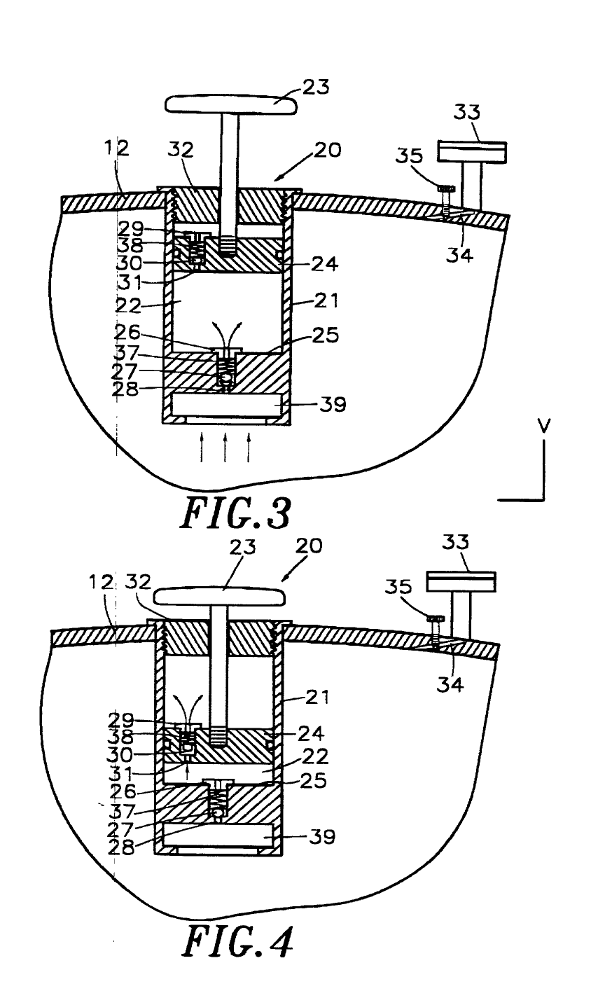

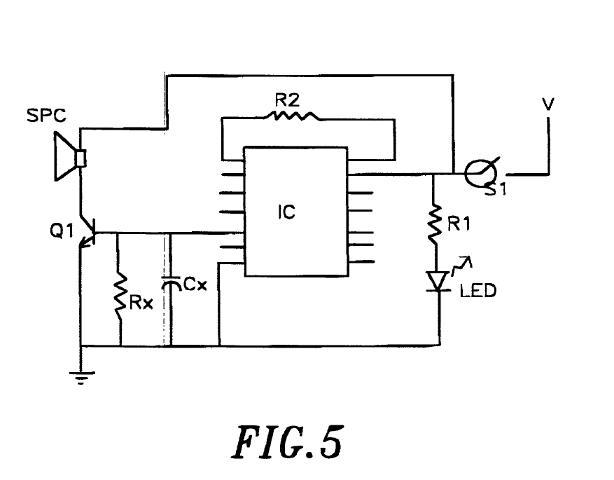

Comparing with FIGS. 3 and 4 simultaneously, the foresaid vacuum pump 20 comprises a pump 21 of the foresaid cover 12, in which there is a pump space 22 with variable capacity sealed by a stopper 32, a stationary base 25 and a piston 24 inside. The foresaid piston 24 can be operated outside to make reciprocating motion in the pump 21 by a manual or electric operating shaft 23 to vary the capacity of pump space 22. The base 25 on the foresaid pump space 22 sets a first non-return valve 26, in which a steel ball 27 in a ball bearing seals an inhaled hole 28 of the base bottom. In addition, the foresaid piston 24 sets a second non-return valve 29, in which a steel ball 30 in a ball bearing seals an air vent 31 of the base bottom.

Please refer to FIG. 3, the piston 24 moves upward white the foresaid operating shaft 23 is putted upward to make the capacity of pump space 22 larger to proceed a resist compression; meanwhile, the air pressure inside the main body 10 is greater than the air pressure inside the pump space 22 so as to push the steel ball 27 of first non-return valve 26 to make the spring 37 elasticity move upward to open the said inhaled hole 28 to cause the air inside the main body 10 to flow the foresaid pump space 22 through the opened first non-return valve 26. As or the second non-return valve 29 makes the foresaid steel ball 30 keep seat the foresaid air vent 31 since the outer air pressure is larger than the inner air pressure of pump space 22.

Referring to FIG. 4, the piston 24 moves downward white the foresaid operating shaft 23 is pushed downward to compress the air inside the pump space 22; at this time, the air pressure inside the pump space 22 is larger than the outer air pressure to utilize the different air pressure to push the steel ball 30 of second non-return valve 29 then to make the spring 38 elasticity move upward to open the said air vent 31 to cause the air inside the pump space 22 to flow outside through the opened second non-return valve 29. As for the first non-return valve 26 makes the foresaid steel ball 27 still seal it's the inhaled hole 28 since the air pressure inside pump space 22 is larger than the inner air pressure of main body 10. Therefore, the air inside the pimp space 22 flows outside when the foresaid operating shaft 23 is pushed downward. The user only needs to reciprocate the foresaid operating shaft 23 by hands or a motor to extract the air in the main body 10 gradually to make the main body 10 become vacuum so that the remains and cremains would not be spoiled and be preserved for long range.

Moreover, the foresaid main body 10 or the cover 12 can add a vacuum meter 33 to know the vacuum degree of inner main body 10 so as to decide whether the remaining air inside the main body 10 should be extracted by vacuum pump 20. The foresaid vacuum meter connects with the inner main body 10 by a vent hole 34 to know the vacuum degree of the inner jar. The foresaid vent hole 34 is seated ordinarily by a needle valve 35 to keep away from the outer air permeating the main body 10. The needle valve 25 is unseated in the control of checking the vacuum status of inner jar or extracting the vacuum process.

The base of foresaid vacuum pump 20 can further set a filter 39 such as the material of sponge or other material to keep off the minor cremains preserved inside the main body 10 flowing out with the air. Please refer to FIG. 2, several protruding pillars 36 can be further added on the base inside the main body 10 in which a hung inner box 40 is topped with a lid 41 to put the remains or cremains inside. Such preserved methods of suspending arrangement and keeping vacuum can prevent to conduct any heat source from outside to spoil the remains or cremains through the material of main body 10 and air. In addition, the inner box 40 is pressed by a lid 41 in order to avoid the minor preserved cremains in the inner box 40 flowing out.

The foresaid vacuum cinerary jar comprises a beeper, in which utilizing a power V provided by a battery and the power terminal connect with a switch 51. When turning on the switch, an electric current transmits to pass an electric resistance R1 then to pass LED to light up so as to show the status of transmit. Furthermore, the electric current transmits a voice integrated circuit IC that is completed by burnt. The two electric terminals of the foresaid voice integrated circuit IC connect with R2 as musical scale adjuster and collocate an amplifier that consists of Rx, Cx and a transistor Q1. After amplifying the burnt circuit such as the voice integrated circuit IC of chant or music transmit the musical scale adjuster and voice amplifier, the sound such as chant or music can be amplify via the amplifier.

Comparing the present invention of vacuum cinerary jar with prior cinerary jar, the present invention is provided with the merits mentioned below:

1. Extracting the air from a vacuum cinerary jar via manual or electric operating pump completely isolates the remains and cremains inside jar from the outside air so that the remains and cremains would not be spoiled and be preserved for long range;

2. the present invention prevents the outside heat source from conducting in order to avoid the remains inside the jar spoiling;

3. simple operation and operate repeatedly keep the cinerary jar vacuum, and

4. a beeper is set to selectively broadcast the sound as chant or music.

Many changes and modification in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. a vacuum cinerary jar comprising:
(a.) a hollow main body with an end of open atone;
(b.) a cover topping on said end of open of said main body;
(c.) an integrated element to keep pressurization between said cover and said main body by compressing method, and
(d.) a vacuum pump fixed on said main body to extract remaining air inside from said main body to outside.

2. a vacuum cinerary jar as claimed in claim 1, wherein said vacuum pump comprises a pump fixed on said vacuum cinerary jar, in which said pump space with variable capacity is sealed by a stopper, a stationary base and a piston inside; said piston being operated outside to make reciprocating motion in said pump by a manual or electric operating shaft to vary capacity of said pump space; said base on said pump space setting a first non-return valve, in which a steel ball within elastic bearing seals an inhaled hole of said base bottom; furthermore, said piston setting a second non-return valve, in which a second steel ball within elastic bearing of said piston seats an air vent of said base bottom.

3. a vacuum cinerary jar as claimed in claim 1, wherein an edge of said end of open of said main body has a protruding ring rim to be topped with an upper protruding ring in which sets a protection element.

4. a vacuum cinerary jar as claimed in claim 3, wherein a C-ring link components can encompass said protruding ring rim and said upper protruding ring; simultaneously utilize a lock bolt to tighten two edges of protruding pieces in order to compress said cover and said main body.

5. a vacuum cinerary jar as claimed in claim 1, further containing a vacuum meter on said vacuum cinerary, a vent hole which leads air from inner main body to said vacuum meter.

6. a vacuum cinerary jar as claimed in claim 1, wherein a further fitter sets on bottom of said vacuum pump to separate minor materials from discharging outside with air.

7. a vacuum cinerary jar as claimed in claim 1, wherein several protruding pillars can be further added on said base inside said main body so as to place a hung inner box topped with a lid.

8. a vacuum cinerary jar as claimed in claim 1, further containing a beeper including a switch, a voice integrated circuit connecting with a musical scale adjuster and an amplifier to broadcast sound.
